(19) United States
(12) Patent Application Publication
(10) Pub. No.: US 2007/0158986 A1
(43) Pub. Date: Jul. 12, 2007

(54) Adjustable sun lounge

(75) Inventors: John K. Adams, Evergreen, CO (US); Ronald D. Dunning, Rockford, OH (US)

Correspondence Address: BAKER & DANIELS LLP;111 E. WAYNE STREET, SUITE 800, FORT WAYNE, IN, 46802, US

(73) Assignee: Porter, Inc. d/b/a Thunderbird Products, Decatur, IN (US)

(21) Appl. No.: 11/641,351

(22) Filed: Dec. 19, 2006

Related U.S. Application Data
(60) Provisional application No. 60/753,255, filed on Dec. 22, 2005.

(51) Int. Cl. B60N 2/02

(52) U.S. Cl. 297/342

(57) ABSTRACT

An adjustable sun lounge for a performance or pleasure boat. The sun lounge converts from a seating configuration into a sunbathing configuration. The sun lounge generally includes a backrest which is movable via a double-pivot hinge and guided by a guide arm from an upright position to a substantially horizontal position. The sun lounge also includes a sunpad and a center cushion movable via a single-pivot hinge from an inclined position to a substantially horizontal position. When the backrest is in the substantially horizontal position and the center cushion is in the substantially horizontal position, the sun lounge is substantially horizontal and flat to accommodate a sunbathing person stretched out thereon. In the upright position, the backrest forms part of a seat structure which may be used when sunbathing is not desired, for example, while the boat is moving.

### CROSS REFERENCE TO RELATED APPLICATIONS

This application claims the benefit under Title 35, U.S.C. § 119(e) of U.S. Provisional Patent Application Ser. No. 60/753,255, entitled ADJUSTABLE SUN LOUNGE, filed Dec. 22, 2005, the entire disclosure of which is hereby expressly incorporated herein by reference.

### BACKGROUND

1. Field of the Invention

The present invention relates to adjustable lounges, and, more particularly, to adjustable sun lounges for use in performance and pleasure boats as well as performance cruisers.

2. Description of the Prior Art

A typical sun lounge in a boat requires substantial movement of a seat cushion or support structure in order to switch between a seating configuration and a sunpad configuration which provides a flat surface upon which to lay for sunbathing, for example. The substantial movement is required, in part, because the seat cushion or support structure must first be vertically lifted and then rotated to provide the sunpad configuration. Such vertical lifting action and rotation typically requires substantial strength to successfully complete the switch to the sunpad configuration. Consequently, this movement may be difficult for a person of relatively smaller stature or for a person who is relatively weak. Additionally, such vertical lifting action and rotation may be cumbersome, even for a person with relatively great strength, if the person's hands are wet, which often occurs in the boat due to splashing of water or from recently exiting the water.

Alternatively, sun lounges in a boat may be permanent structures and are not convertible into a seat structure or seating configuration. Furthermore, such permanent structures are often too short to fully accommodate a person's entire body length because the overall dimensions of the boat prohibit such large permanent structures.

### SUMMARY

The present invention generally provides an adjustable sun lounge for a performance or pleasure boat. The sun lounge converts from a seating configuration into a sunbathing configuration. In one embodiment, the sun lounge includes a backrest which is movable via a double-pivot hinge and guided by a guide arm from an upright position to a substantially horizontal position. The sun lounge can also include a sunpad and a center cushion movable via a single-pivot hinge from an inclined position to a substantially horizontal position. When the backrest is in the substantially horizontal position and the center cushion is in the substantially horizontal position, the sun lounge is substantially horizontal and flat to accommodate a sunbathing person stretched out thereon. In the upright position, the backrest forms part of a seat structure which may be used when sunbathing is not desired, for example, while the boat is moving.

Advantageously, the adjustable sun lounge can readily convert from the seating configuration to the sunbathing configuration with minimal effort. Moreover, the guide arm advantageously provides guidance to the sun lounge while converting from the seating configuration to the sunbathing configuration.

In one form thereof, the present invention provides an adjustable lounge for use in a watercraft, including a convertible seatback hingedly connected to the watercraft and pivotally movable with respect to the watercraft from an upright position to a substantially horizontal position; a double-pivot hinge attached to the convertible seatback and the watercraft; and a guide arm, the guide arm attached to the convertible seatback and the watercraft.

In another form thereof, the present invention provides a convertible seating apparatus for use in a watercraft, including a convertible seatback, the convertible seatback pivotally movable from an upright position to a substantially horizontal position; a lounge surface, the lounge surface pivotally movable from an inclined position to a substantially horizontal position; a double-pivot hinge attached to the convertible seatback and the watercraft; and a guide arm, the guide arm attached to the convertible seatback and the watercraft.

In yet another form thereof, the present invention provides a boat, including a hull; a support structure connected to the hull; and a convertible seating apparatus connected to the support structure, the seating apparatus including a convertible seatback, the convertible seatback pivotally movable from an upright position to a substantially horizontal position; a lounge surface, the lounge surface pivotally movable from an inclined position to a substantially horizontal position; a double-pivot hinge attached to the convertible seatback and the support structure; and a guide arm, the guide arm attached to the convertible seatback and the support structure.

### BRIEF DESCRIPTION OF THE DRAWINGS

The above mentioned and other features and objects of this invention, and the manner of attaining them, will become more apparent and the invention itself will be better understood by reference to the following description of exemplary embodiments of the invention taken in conjunction with the accompanying drawings, wherein:

FIG. 1 is a perspective view of a boat with an exemplary embodiment adjustable sun lounge, further illustrating the sun lounge in a first or seating configuration;

FIG. 2 is a perspective view of the adjustable sun lounge of FIG. 1, further illustrating a backrest of the sun lounge in an upright position and a center cushion of the sun lounge in an inclined position;

FIG. 3 is a perspective view of the adjustable sun lounge of FIG. 1, further illustrating a support structure mounted alongside the sun lounge;

FIG. 4 is a side view of the adjustable sun lounge of FIG. 2;

FIG. 5 is a side view of the adjustable sun lounge of FIG. 2, further illustrating the backrest of the sun lounge moved to a substantially horizontal position;

FIG. 6 is a partial perspective view of the center cushion of the sun lounge of FIG. 2;

FIG. 7 is a partial perspective view of a portion of the sun lounge of FIG. 3, further illustrating a release pin;

FIG. 8 is a side view of the adjustable sun lounge of FIG. 2, further illustrating the backrest of the sun lounge in the substantially horizontal position and the center cushion of the sun lounge moved to a substantially horizontal position;

FIG. 9 is a perspective view of the sun lounge of FIG. 2, further illustrating the sun lounge converted to a second or sunbathing configuration;

FIG. 10 is a perspective view of the sun lounge of FIG. 9, further illustrating the support structure mounted alongside the sun lounge; and

FIG. 11 is a bottom perspective view of the backrest of the sun lounge of FIG. 2, further illustrating a guide arm and a mounting structure with a double-pivot hinge attached thereto.

Corresponding reference characters indicate corresponding parts throughout the several views. Although the drawings represent embodiments of the present invention, the drawings are not necessarily to scale and certain features may be exaggerated in order to better illustrate and explain the present invention. The exemplifications set out herein illustrate embodiments of the invention, and such exemplifications are not to be construed as limiting the scope of the invention in any manner.

### DETAILED DESCRIPTION

The embodiments disclosed below are not intended to be exhaustive or limit the invention to the precise forms disclosed in the following detailed description. Rather, the embodiments are chosen and described so that others skilled in the art may utilize their teachings.

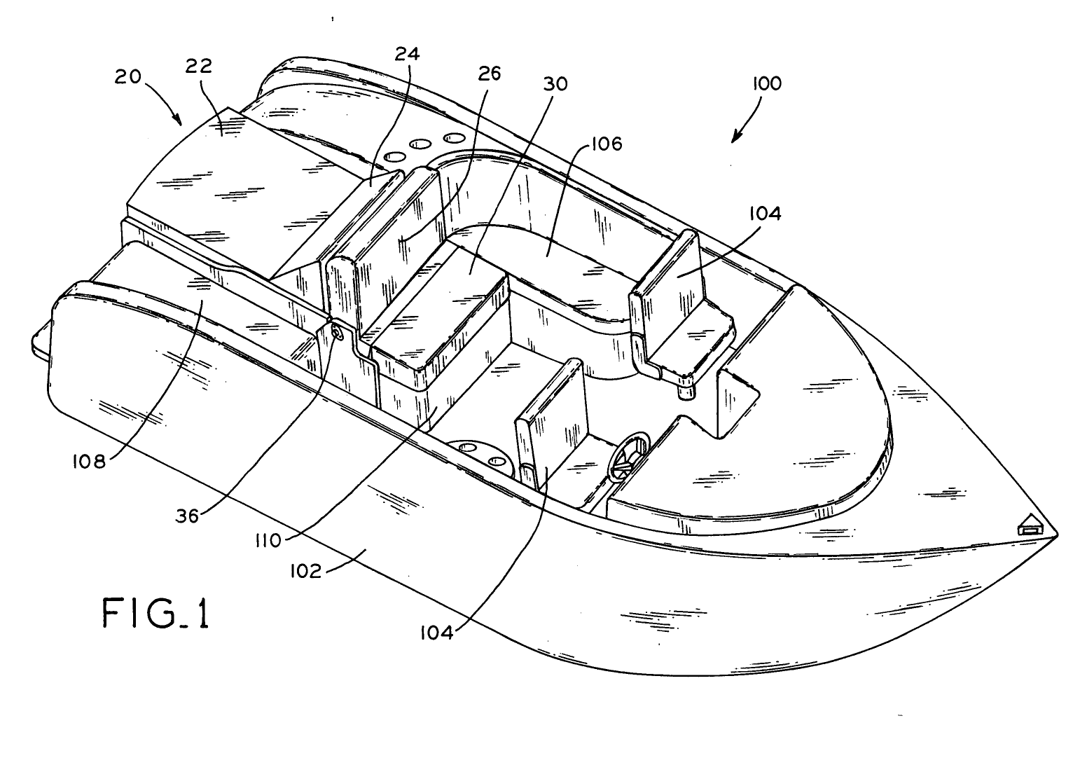

Referring to FIG. 1, boat 100 generally includes hull 102, two or more chairs 104, seat 106, and walkway 108. Seat support structure 110 is disposed proximate walkway 108 and supports at least a portion of adjustable sun lounge 20, as described hereinafter.

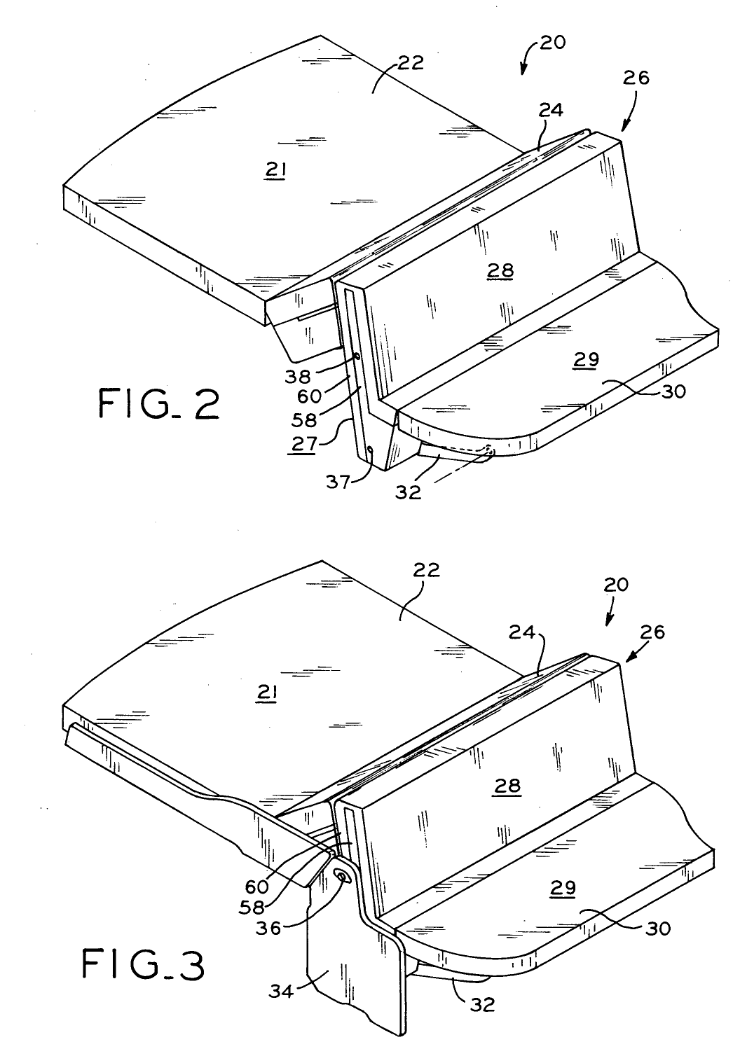

Referring now to FIGS. 2-3, adjustable sun lounge 20 is shown in a first or seating configuration and may include sunpad 22, center cushion or lounge surface 24, backrest or convertible seatback 26, and seat 30. Backrest 26 includes front surface 28 which functions as a backrest for a person seated on top surface 29 of seat 30 when sun lounge 20 is in the first or seating configuration.

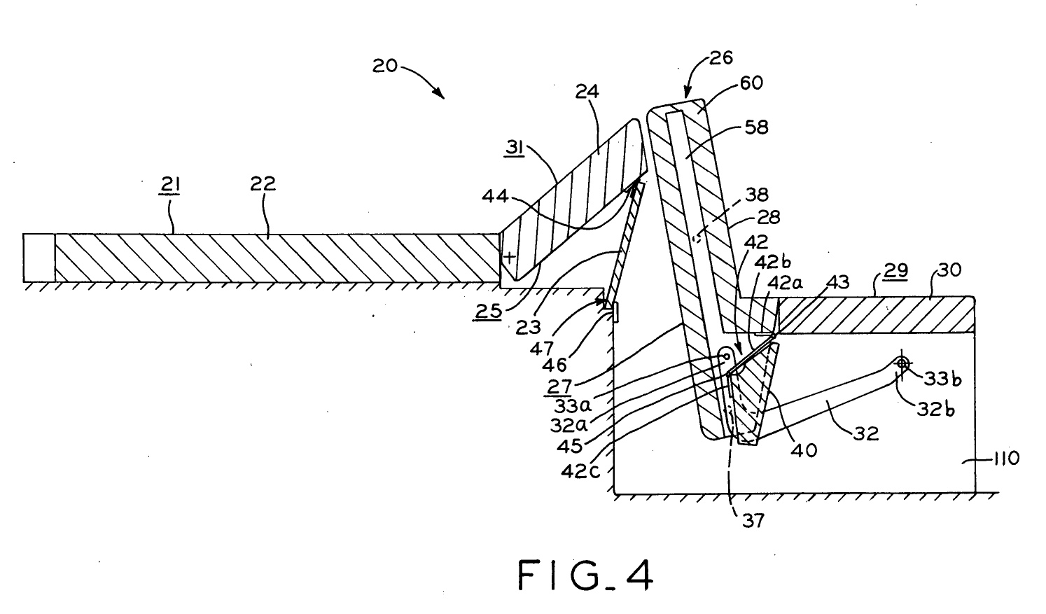

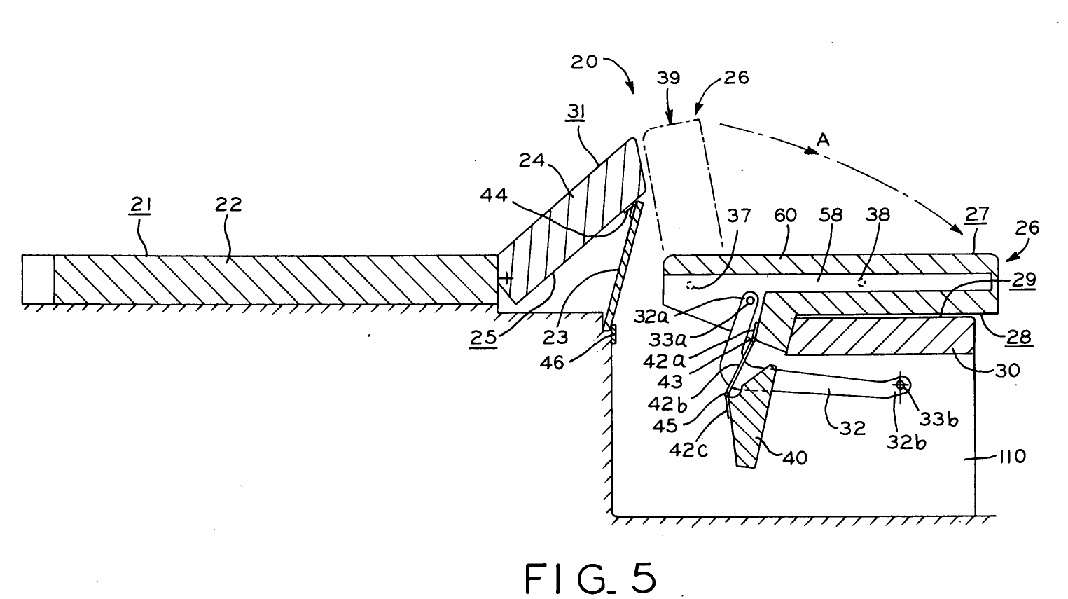

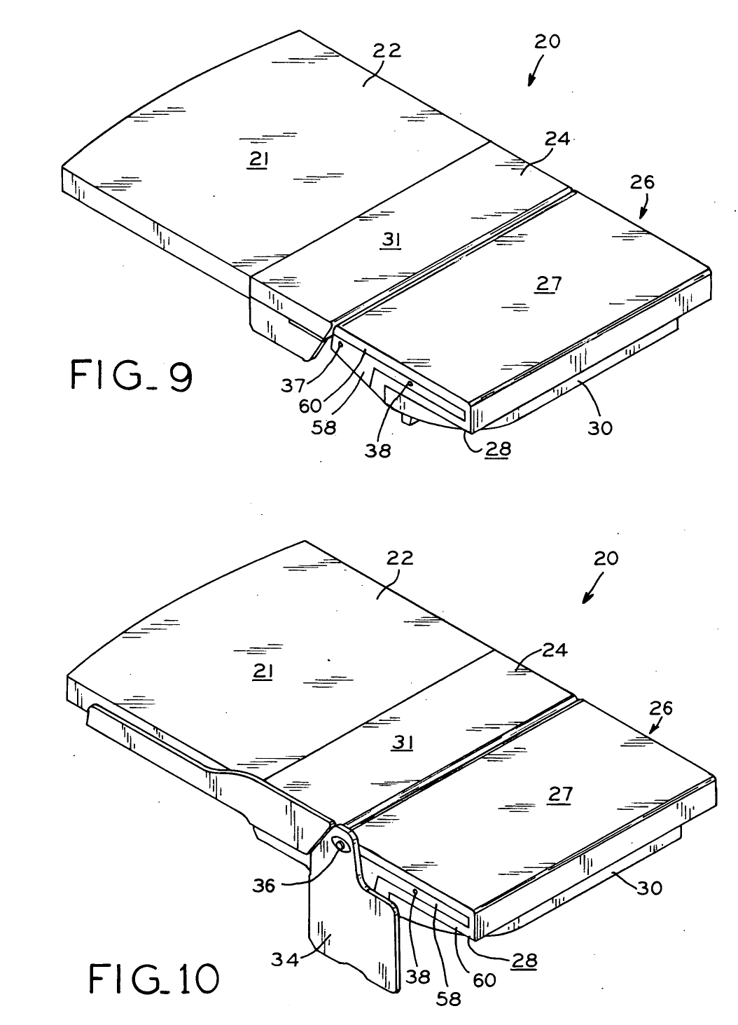

As shown in FIGS. 4-5, backrest 26 may include foam or resilient portion 60 and solid portion 58. Solid portion 58 may be constructed of a material such as metal, plastic, wood, or other structurally rigid material. Solid portion 58 includes apertures 37 and 38. Apertures 37 and 38 are sized to accept release pin 36 (FIG. 7) to permit selective locking of backrest 26 in the seating configuration (FIGS. 2-3) or in a second or sunbathing configuration (FIGS. 9-10) where all surfaces, i.e., surfaces 21, 31, and 27, are substantially horizontal and flush with each other to create an elongated sunpad which accommodates the entire length of a user. Foam portion 60 of backrest 26 may be covered with a vinyl material or any other moisture-durable material. Sunpad 22 may also be constructed of any material sufficient to support the weight of a person. Sunpad 22 may also be covered with a vinyl material or any other moisture-durable material.

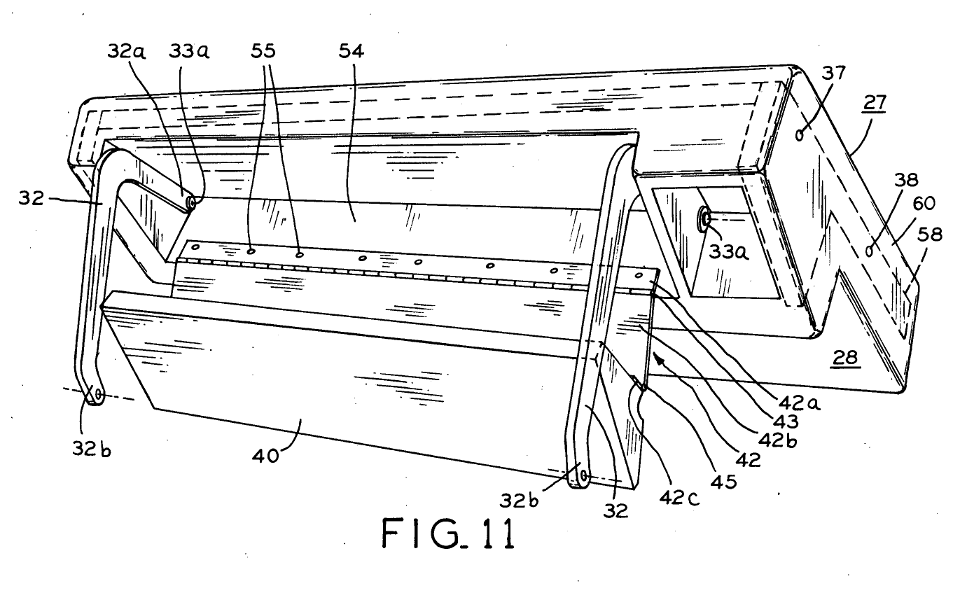

As shown in FIGS. 4 and 11, backrest 26 is attached to seat support structure 110 via guide arm 32 with fasteners 33. Specifically, fastener 33a attaches end 32a of guide arm 32 to solid portion 58 of backrest 26 (FIG. 11) and fastener 33b attaches end 32b of guide arm 32 to support structure 110 (FIG. 4). Guide arm 32 allows pivotal movement of backrest 26 relative to seat support structure 110 while simultaneously and advantageously maintaining the correct fore and aft relationship between backrest 26 and support structure 110. Backrest 26 is also attached to mounting structure 40 via double-pivot hinge 42. Mounting structure 40 may be an integral part of support structure 110, or separately secured to support structure 110, and forms a permanent, non-movable (relative to sun lounge 20) portion of boat 100. Double-pivot hinge 42 lifts and supports backrest 26 and includes component 42a pivotally connected to component 42b which is pivotally connected to component 42c. Component 42c is attached via a plurality of fasteners (not shown) to mounting structure 40. Alternatively, component 42c could be attached to mounting structure 40 via any other suitable connection, such as welding or adhesive, or integrally formed therewith. Component 42a is attached via a plurality of fasteners 55 (FIG. 11) to attachment surface 54 on backrest 26. Alternatively, component 42a could be attached to backrest 26 via any other suitable connection, such as welding or adhesive, or integrally formed therewith.

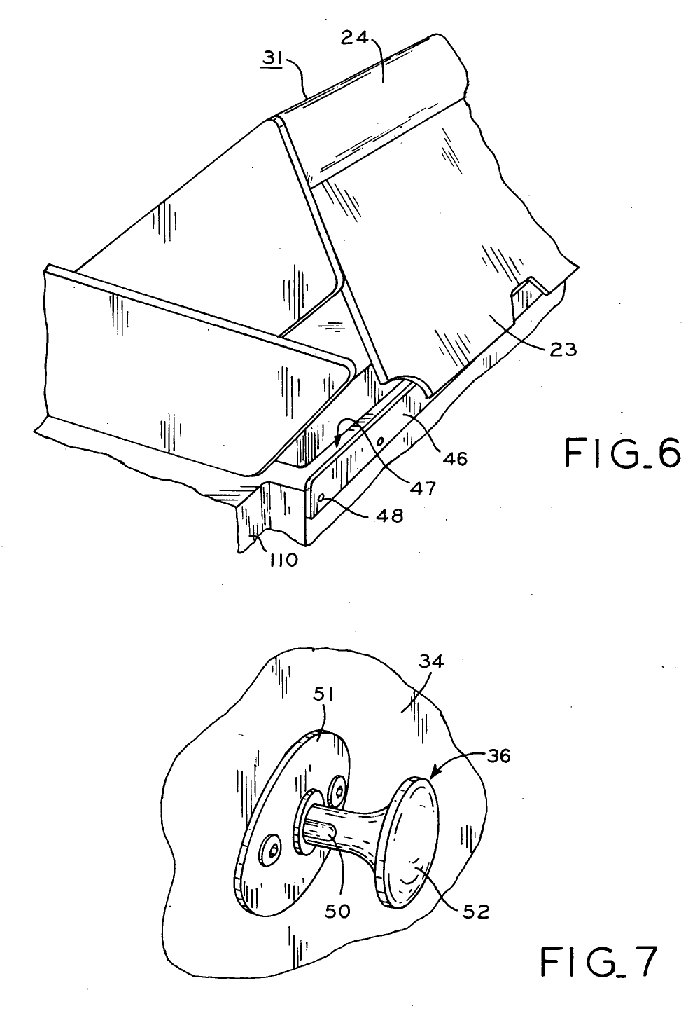

Center cushion 24 of sun lounge 20 is movable between a first or inclined position (FIGS. 2-5) and a second or substantially horizontal position (FIGS. 9-10). As shown in FIGS. 4-5, center cushion 24 includes top surface 31, bottom surface 25, and support panel 23 attached thereto via single-pivot hinge 44. Hinge 44 may be attached to support panel 23 and bottom surface 25 via a plurality of fasteners (not shown), an adhesive, welding, or any other attachment. Support panel 23 may be a plastic or other water-resistant solid material. When center cushion 24 is moved to the inclined position as shown in FIGS. 4-5, center cushion 24 is supported via the engagement of support panel 23 with groove 47 (FIGS. 4 and 6) constructed with support structure 46. Support structure 46 may be attached via a plurality of fasteners 48 (FIG. 6) to seat support structure 110 or any other portion of boat 100. When support panel 23 engages with groove 47, support panel 23 is prohibited from translating either fore or aft and thus is maintained in a position to support center cushion 24 in the inclined position. Center cushion 24 may be constructed of material including a foam portion and having sufficient rigidity to support the weight of a person. Center cushion 24 may also be covered with a vinyl material or any other moisture-durable material.

Referring now to FIGS. 3, 7, and 10, sun lounge 20 also includes release pin 36 which prevents adjustment or conversion of backrest 26 when not desired. Release pin 36 includes key 50 and head 52. Release pin 36 enters backrest 26 via pin bracket 51 which is affixed to support structure 34 (FIG. 3). Once extended through bracket 51 and support structure 34, release pin 36 engages either aperture 37 (FIGS. 2 and 9) or aperture 38 (FIGS. 2 and 9), depending on the configuration of backrest 26. For example, release pin 36 engages aperture 37 when backrest 26 is in the sunbathing configuration (FIGS. 9-10) and release pin 36 engages aperture 38 when backrest 26 is in the seating configuration (FIGS. 2-3).

In operation and referring to FIGS. 4, 5, and 7, to move backrest 26 from a first or upright position to a second or substantially horizontal position, a person must first disengage release pin 36 from engagement with aperture 38 (FIG. 2) by pulling release pin 36 away from support structure 34. Once release pin 36 is sufficiently removed from aperture 38, a user may move backrest 26 in the general direction of Arrow A, shown in FIG. 5, by grasping backrest 26 near end portion 39 thereof and moving backrest 26 in the direction of Arrow A. Guide arm 32 allows backrest 26 to pivot relative to seat support structure 110, i.e., fasteners 33a and 33b allow guide arm 32 to pivot about both backrest 26 and seat support structure 110, thereby pivoting backrest 26 relative to seat support structure 110. Guide arm 32 also advantageously maintains a correct fore and aft relationship between backrest 26 and support structure 110. The double-pivot, lifting and supporting action of hinge 42 allows a smooth and easy movement of backrest 26 from the upright position, shown in dashed lines in FIG. 5, to the substantially horizontal position, shown in solid lines in FIG. 5, where front surface 28 lies flat against or parallel with and proximate to top surface 29 of seat 30 and top surface 27 is substantially flush with surface 21 of sunpad 22. During movement of backrest 26 in the general direction of Arrow A, component 42a of hinge 42 moves with backrest 26 via attachment to attachment surface 54 (FIG. 11) thereof, and pivots about pivot pin 43 between component 42a and component 42b. Component 42a pivots in a clockwise rotation as viewed in FIGS. 4 and 5. When rotating backrest 26 into the substantially horizontal position, component 42b pivots about pivot pin 45 between component 42b and component 42c and component 42b pivots in a counterclockwise rotation as viewed in FIGS. 4 and 5. Component 42b moves upward and away from mounting structure 40 and supports backrest 26 while component 42a facilitates pivoting backrest 26 into the position shown in solid lines in FIG. 5. Once in the position shown in solid lines in FIG. 5, backrest 26 may be releasably locked to prevent relative rotation of backrest 26 with respect to boat 100 by reinserting release pin 36 through bracket 51 and into aperture 37.

To move backrest 26 from the substantially horizontal position (FIG. 5) to the upright position (FIG. 4), the above-described steps may be repeated in reverse order.

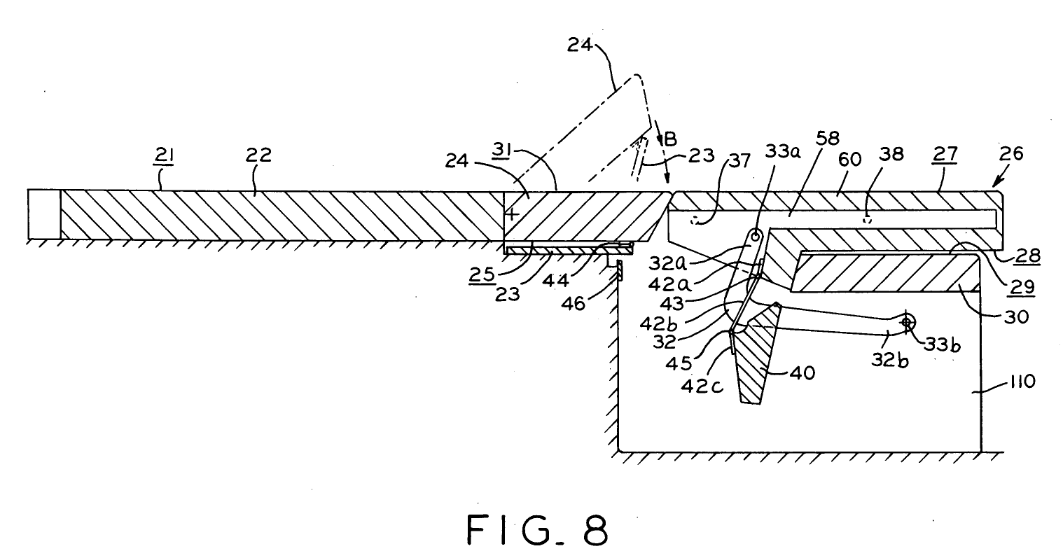

In operation and referring to FIGS. 6 and 8, to move center cushion 24 from the inclined position to the substantially horizontal position and thereby complete formation of the sunbathing configuration of sun lounge 20, a user must first slightly lift center cushion 24 upwards, thereby removing support panel 23 from engagement with groove 47. Once support panel 23 is removed from groove 47, support panel 23 is folded under center cushion 24 via hinge 44 such that it lays substantially parallel to top surface 31. Center cushion 24 is then moved in the general direction of Arrow B (FIG. 8) until top surface 31 of center cushion 24 is substantially flush with top surface 21 of sunpad 22.

To move center cushion 24 from the substantially horizontal position (FIGS. 9-10) to the inclined position (FIGS. 2-3), the above-described steps may be repeated in reverse order.

In the seating configuration, sun lounge 20 can accommodate one or more persons seated on seat 30 as well as one or more persons reclining on center cushion 24 and sunpad 22. Once backrest 26 is moved to the substantially horizontal position and center cushion 24 is moved to the substantially horizontal position, sun lounge 20 forms the sunbathing configuration with a substantially horizontal, flat surface, shown in FIGS. 9 and 10, which can accommodate a body length of a person for one or more persons sunbathing on lounge 20.

While this invention has been described as having exemplary designs, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. An adjustable lounge for use in a watercraft, comprising:
a convertible seatback hingedly connected to the watercraft and pivotally movable with respect to the watercraft from an upright position to a substantially horizontal position;
a double-pivot hinge attached to said convertible seatback and the watercraft; and
a guide arm, said guide arm attached to said convertible seatback and the watercraft.

2. The adjustable lounge of claim 1, wherein said guide arm is pivotally attached to said convertible seatback and the watercraft.

3. The adjustable lounge of claim 1, further comprising a locking pin engageable with said convertible seatback and a portion of the watercraft to lock said convertible seatback in one of said upright position and said substantially horizontal position.

4. The adjustable lounge of claim 1, wherein said guide arm comprises an L-shaped structure connected at a first end to said convertible seatback and at a second end to the watercraft.

5. The adjustable lounge of claim 1, wherein said convertible seatback comprises a front surface forming a backrest when said convertible seatback is in said upright position.

6. The adjustable lounge of claim 5, wherein said convertible seatback further comprises a top surface opposite said front surface, said top surface useable when said convertible seatback is in said substantially horizontal position.

7. A convertible seating apparatus for use in a watercraft, comprising:
a convertible seatback, said convertible seatback pivotally movable from an upright position to a substantially horizontal position;
a lounge surface, said lounge surface pivotally movable from an inclined position to a substantially horizontal position;
a double-pivot hinge attached to said convertible seatback and the watercraft; and
a guide arm, said guide arm attached to said convertible seatback and the watercraft.

8. The convertible seating apparatus of claim 7, wherein said guide arm is pivotally attached to said convertible seatback and the watercraft.

9. The convertible seating apparatus of claim 7, further comprising a locking pin engageable with said convertible seatback and a portion of the watercraft to lock said convertible seatback in one of said upright position and said substantially horizontal position.

10. The convertible seating apparatus of claim 7, wherein said guide arm comprises an L-shaped structure connected at a first end to said convertible seatback and at a second end to the watercraft.

11. The convertible seating apparatus of claim 7, wherein said convertible seatback comprises a front portion forming a backrest when said convertible seatback is in said upright position.

12. The convertible seating apparatus of claim 7, wherein said lounge surface comprises a seat portion and a support portion, said support portion hingedly connected to said seat portion.

13. The convertible seating apparatus of claim 12, wherein said support portion is engageable with the watercraft to support said lounge surface when said lounge surface is in said inclined position.

14. A boat, comprising:
a hull;
a support structure connected to said hull; and
a convertible seating apparatus connected to said support structure, said seating apparatus comprising:
a convertible seatback, said convertible seatback pivotally movable from an upright position to a substantially horizontal position;
a lounge surface, said lounge surface pivotally movable from an inclined position to a substantially horizontal position;
a double-pivot hinge attached to said convertible seatback and said support structure; and
a guide arm, said guide arm attached to said convertible seatback and said support structure.

15. The boat of claim 14, wherein said guide arm is pivotally attached to said convertible seatback and said support structure.

16. The boat of claim 14, further comprising a locking pin engageable with said convertible seatback and a portion of said support structure to lock said convertible seatback in one of said upright position and said substantially horizontal position.

17. The boat of claim 14, wherein said guide arm comprises an L-shaped structure connected at a first end to said convertible seatback and at a second end to said support structure.

18. The boat of claim 14, wherein said convertible seatback comprises a front portion forming a backrest when said convertible seatback is in said upright position.

19. The boat of claim 14, wherein said lounge surface comprises a seat portion and a support portion, said support portion hingedly connected to said seat portion.

20. The boat of claim 19, wherein said support portion is engageable with said support structure to support said lounge surface when said lounge surface is in said inclined position.
